(19) United States
(12) Patent Application Publication
(10) Pub. No.: US 2021/0136394 A1
(43) Pub. Date: May 6, 2021

(54) ENCODING APPARATUS AND ENCODING METHOD, AND DECODING APPARATUS AND DECODING METHOD

(71) Applicant: CANON KABUSHIKI KAISHA, Tokyo (JP)

(72) Inventor: Daisuke Sakamoto, Kanagawa (JP)

(21) Appl. No.: 17/081,370

(22) Filed: Oct. 27, 2020

(30) Foreign Application Priority Data
Nov. 5, 2019 (JP) 2019-201032

(51) Int. Cl. H04N 19/169; H04N 19/124; H04N 19/186; H04N 19/63

(52) U.S. Cl. CPC H04N 19/1883; H04N 19/63; H04N 19/186; H04N 19/124

(57) ABSTRACT

An encoding apparatus generates low-frequency component subband data and high-frequency component subband data from image data; generates, from low-frequency component subband data generated from first image data, second image data that has a same resolution as that of the first image data. The apparatus obtains a difference between high-frequency component subband data generated from the first image data and high-frequency component subband data generated from the second image data; and encodes the low-frequency component subband data of the first image data and the difference in order to generate encoded data.

### BACKGROUND OF THE INVENTION

### Field of the Invention

The present disclosure relates to an encoding apparatus and encoding method, and a decoding apparatus and decoding method.

### Description of the Related Art

A color filter array (also referred to as “CFA”) is provided in a single-plate color image sensor that is widely used in digital cameras. Filters of a plurality of predetermined colors are regularly arranged in the color filter array. There are various color combinations and arrangement methods for the color filter array, but the primary-color Bayer filter shown in FIG. 2 is representative.

In the primary-color Bayer filter, unit filters of R (red), G0 (green), G1 (green), and B (blue) are cyclically arranged in units of 2*2. One unit filter is provided for each pixel of an image sensor, and thus pixel data that constitutes image data obtained in one instance of shooting includes only information of one color component of RGB. Image data in this state is called RAW image data.

RAW image data is not suitable for display as is. Therefore, usually, various types of image processing are applied so as to convert RAW image data into a format that can be displayed by a general-purpose device (for example, the JPEG format or the MPEG format), and the data is then recorded. However, such a conversion often includes lossy image processing that may degrade image quality, in order to reduce the data amount, for example. Accordingly, some digital cameras have a function to record RAW image data to which the conversion has not been applied.

Data amounts of RAW image data have become very large as the number of pixels of an image sensor increases. Therefore, recording RAW image data after reducing (compressing) the data amount in order to improve the continuous shooting speed, save the capacity of the recording medium, and the like has also been proposed, Japanese Patent Laid-Open No. 2003-125209 discloses a method for separating RAW image data into four planes, namely R, G0, B, G1, and then performing encoding.

### SUMMARY OF THE INVENTION

When image data such as RAW image data is encoded and the data amount is reduced, it is important to improve the compression rate (data reduction rate) while suppressing image quality deterioration caused by encoding. According to an aspect of the present disclosure, an encoding apparatus and an encoding method that realize encoding that suppresses image quality deterioration caused by encoding while achieving an appropriate encoding efficiency are provided.

According to an aspect of the present disclosure, there is provided an encoding apparatus comprising: one or more processors that execute a program comprising instructions that cause, when executed by the one or more processors, the one or more processors to function as: a decomposition unit configured to generate low-frequency component subband data and high-frequency component subband data from image data; a generation unit configured to generate, from low-frequency component subband data generated from first image data by the decomposition unit, second image data that has a same resolution as that of the first image data; a computation unit configured to obtain a difference between high-frequency component subband data generated from the first image data by the decomposition unit and high-frequency component subband data generated from the second image data by the decomposition unit; and an encoding unit configured to encode the low-frequency component subband data of the first image data and the difference in order to generate encoded data.

According to another aspect of the present disclosure, there is provided an image capture apparatus comprising: an image sensor; and the encoding apparatus according to the present disclosure that encodes RAW image data obtained by the image sensor.

According to a further aspect of the present disclosure, there is provided an encoding method that is executed by an encoding apparatus, the method comprising: generating, from low-frequency component subband data generated from first image data, second image data that has a same resolution as that of the first image data; obtaining a difference between high-frequency component subband data generated from the first image data and high-frequency component subband data generated from the second image data; and encoding the low-frequency component subband data of the first image data and the difference in order to generate encoded data.

According to a further aspect of the present disclosure, there is provided a decoding apparatus comprising: one or more processors that execute a program comprises instructions that cause, when executed by the one or more processors, the one or more processors to function as: a decoding unit configured to decode encoded data; a generation unit configured to generate, from low-frequency component subband data out of data obtained by the decoding unit by decoding the encoded data, second image data that has a same resolution as that of image data corresponding to the encoded data; a decomposition unit configured to generate low-frequency component subband data and high-frequency component subband data from the second image data; a computation unit configured to add the high-frequency component subband data generated by the decomposition unit, to high-frequency component subband data out of data obtained by the decoding unit by decoding the encoded data, in order to obtain addition data of high-frequency component subband data; and a frequency recomposition unit configured to perform frequency recomposition on low-frequency components subband data out of the data obtained by the decoding unit by decoding the encoded data, and the addition data of high-frequency component subband data obtained by the computation unit.

According to another aspect of the present disclosure, there is provided a decoding method that is executed by a decoding apparatus, the method comprising: generating, from low-frequency component subband data out of data obtained by decoding encoded data, second image data that has a same resolution as that of image data corresponding to the encoded data; generating low-frequency component subband data and high-frequency component subband data, from the second image data; adding high-frequency component subband data generated from high-frequency component subband data out of the data obtained by decoding the encoded data in order to obtain addition data of high-frequency component subband data; and performing frequency recomposition on low-frequency components subband data out of the data obtained by decoding the encoded data, and on the addition data of the high-frequency component subband data.

Further features of the present disclosure will become apparent from the following description of exemplary embodiments (with reference to the attached drawings).

### BRIEF DESCRIPTION OF THE DRAWINGS

FIGS. 1A and 1B are block diagrams showing exemplary function configurations of an encoding apparatus and a decoding apparatus according to a first embodiment.

FIGS. 2A and 2B are diagrams related to plane conversion in an encoding apparatus.

FIGS. 3A and 3B are diagrams related to reversible 5-3 DWT and reversible 5-3 inverse DWT.

FIG. 4 is a diagram related to subband breakdown.

FIGS. 5A and 5B are diagrams schematically showing an overview of processing of the encoding apparatus and processing of the decoding apparatus according to the first embodiment.

FIG. 6 is a diagram showing a configuration example of neurons constituting a neural network that is used in the first embodiment.

FIGS. 7A and 7B are diagrams showing configuration examples of a neural network that can be used for super-resolution processing in an embodiment of the present disclosure.

FIG. 8 is a schematic diagram related to a method for learning weights and biases used in the neural network in FIG. 7A or 7B.

FIG. 9 is a diagram related to frequency decomposition that uses DCT.

FIG. 10 is a diagram for illustrating a configuration of DC coefficients.

FIGS. 11A and 11B are diagrams related to an exemplary data structure of encoded data in an embodiment of the present disclosure.

FIG. 12 is a diagram related to a detailed example of header information in the exemplary data structure in FIGS. 11A and 11B.

FIGS. 13A and 13B are diagrams for illustrating a specific example of information regarding the neural network in FIG. 12.

FIG. 14 is a diagram related to another detailed example of header information in the exemplary data structure in FIGS. 11A and 11B.

FIGS. 15A and 15B are block diagrams showing exemplary function configurations of an encoding apparatus and a decoding apparatus according to a second embodiment.

FIG. 16 is a diagram related to a detailed example of header information of encoded data according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

Note that an encoding apparatus and a decoding apparatus to be described in embodiments below can be realized in an electronic device that can process image data. Examples of such an electronic device include a digital camera, a computer device (personal computer, tablet computer, media player, PDA, etc.), a mobile phone, a smart phone, a gaining device, a robot, a drone, and a drive recorder. These are exemplary, and the present disclosure is also applicable to other electronic devices.

### First Embodiment

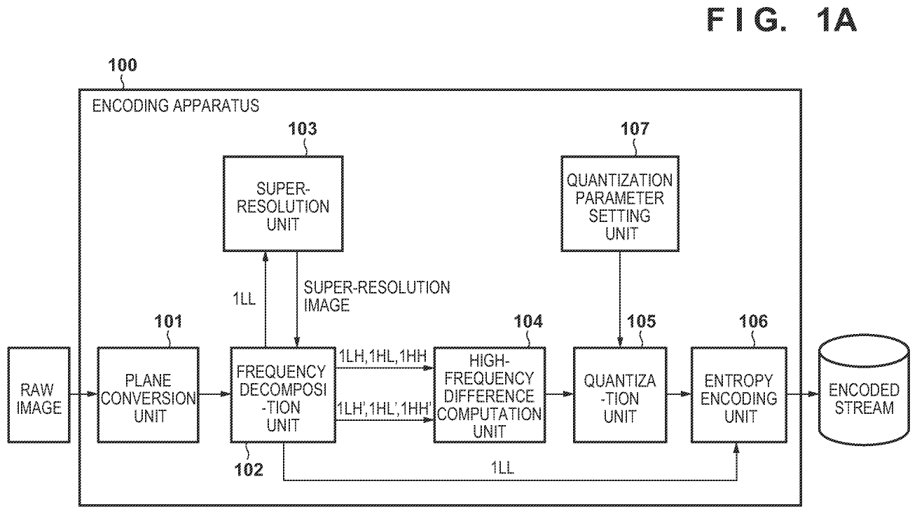

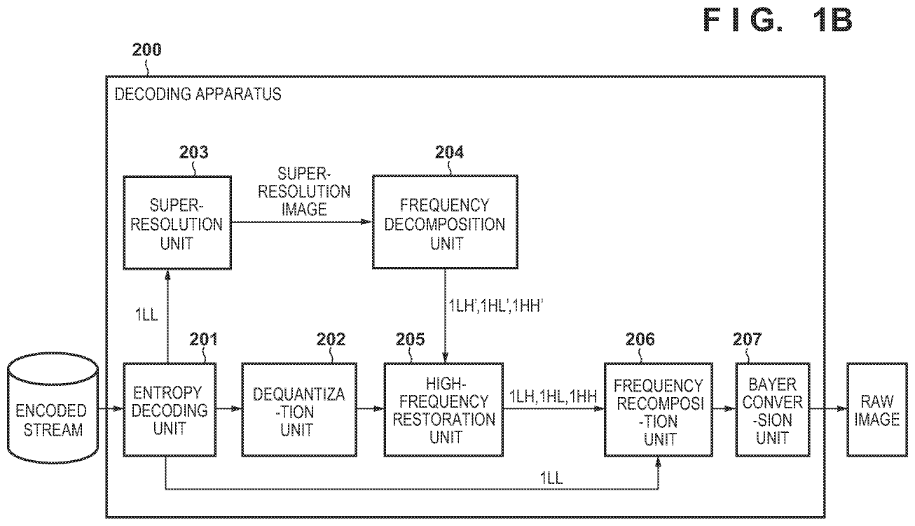

FIG. 1A is a block diagram showing an exemplary function configuration of an encoding apparatus 100 according to an embodiment of the present disclosure. The encoding apparatus 100 includes a plane conversion unit 101, a frequency decomposition unit 102, a super-resolution unit 103, a high-frequency difference computation unit 104, a quantization unit 105, an entropy encoding unit 106, and a quantization parameter setting unit 107. These units (functional blocks) can be realized by a dedicated hardware circuit such as an ASIC, as a result of general-purpose processor such as a DSP or a CPU loading a program stored in a non-volatile memory to a system memory and executing the program, or by a combination thereof. For convenience, a description will be given below assuming that each functional block autonomously operates in cooperation with other functional blocks.

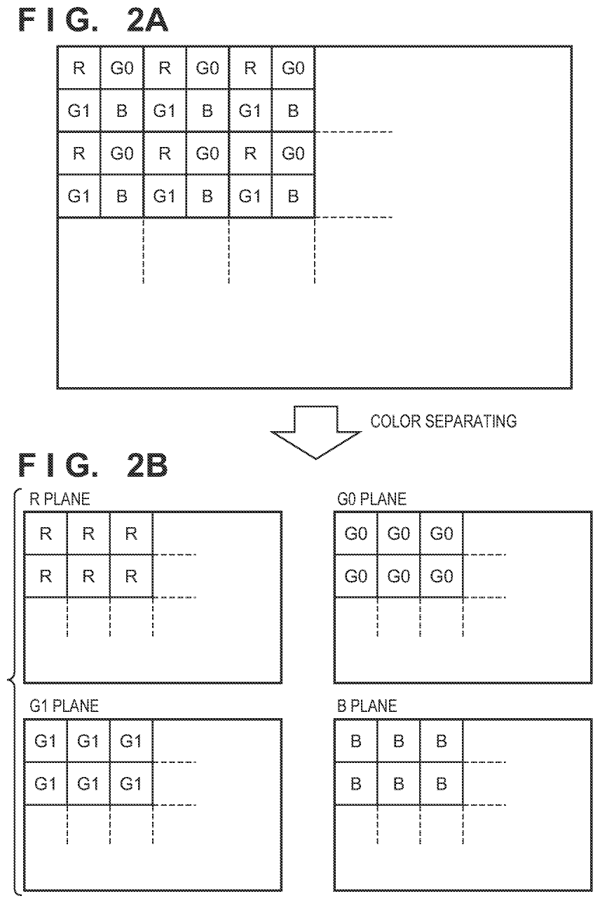

Here, assume that RAW image data (first image data) to be encoded is data read out from image sensor provided with a primary-color Bayer CFA shown in FIG. 2A. The RAW image data is input to the plane conversion unit 101.

As shown in FIG. 2B, the plane conversion unit 101 separates RAW image data into groups (planes) in accordance with the color arrangement of the CFA, and supplies the groups to the frequency decomposition unit 102. Here, the plane conversion unit 101 groups pixel data obtained from pixels that include filters of the same type, from among four types of filters, namely R, G0, G1, and B filters that constitute the CFA in the primary-color Bayer array. A group of pixel data obtained from pixels that include the R filters (R pixels) is referred to as an “R plane”. Therefore, the plane conversion unit 101 separates RAW image data into an R plane, a G0 plane, a G1 plane, and a B plane, and supplies the planes to the frequency decomposition unit 102.

The frequency decomposition unit 102 once executes reversible 5-3 discrete wavelet transform (DWT) on data of each of the planes input from the plane conversion unit 101. 5-3 DWT is DWT that uses a 5-tap low-pass filter (LPF) and a 3-tap high pass filter (HPF), and is also called 5/3 DWT.

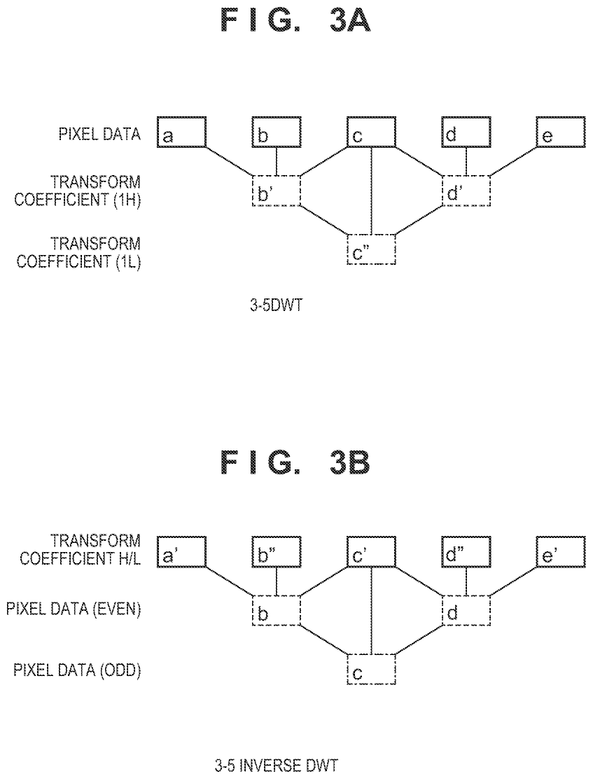

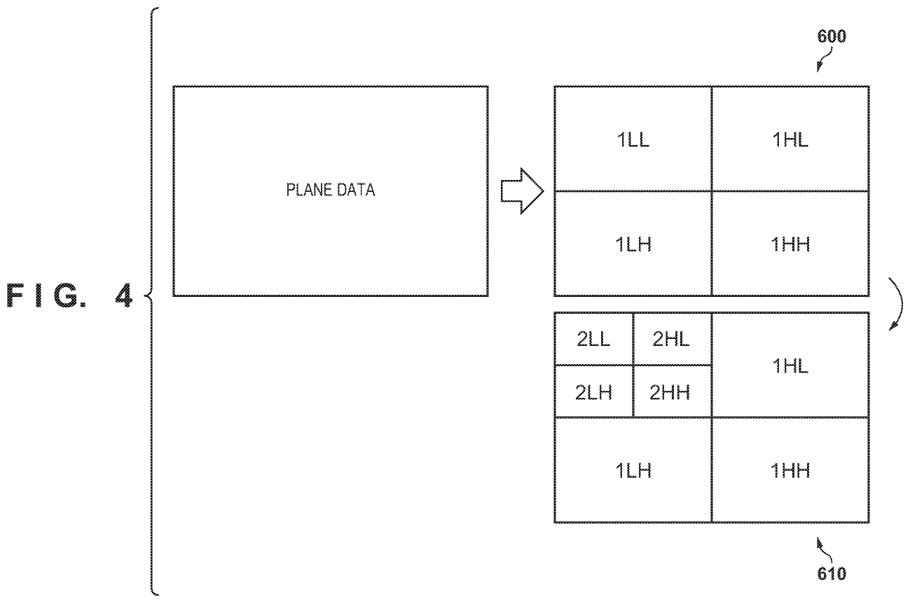

Here, a specific method for applying reversible 5-3 DWT will be described with reference to FIGS. 3A and 4. In FIG. 3A, a to e denote pixel data rows, b′ and d′ denote DWT coefficients of high-frequency components generated as a result of executing DWT, and c″ denotes a DWT coefficient of a low-frequency component generated as a result of executing DWT. The DWT coefficients b′ and d′ of high-frequency components are obtained using the pieces of pixel data a to e based on Expressions 1 and 2 below.

b′=b−(a+c)/2 (1)

d′=d−(c+e)/2 (2)

Expressions 1 and 2 use different pieces of pixel data, but computation in the equations is the same.

In addition, the DWT coefficient c″ of a low-frequency component is obtained from the pieces of pixel data a to e and the DWT coefficients b′ and d′ of high-frequency components based on Expression 3 or 4 below.

c″=c+(b′+d′+2)/4 (3)

c″=(a+2b+6c+2d−e)/8 (4)

DWT shown in FIG. 3A is one-dimensional DWT. As a result of carrying out one-dimensional DWT on data of each of the planes in the vertical direction and horizontal direction, two-dimensional DWT can be realized. As a result of two-dimensional DWT, plane data is broken down into four pieces of subband (frequency component) data, namely 1LL, 1LH, 1HL, and 1HH, as indicated by 600 in FIG. 4.

The 1HH subband represents a high-frequency component subband at a level 1 both in the horizontal direction and vertical direction. As shown in FIG. 4, the numbers of coefficients in the horizontal direction and the vertical direction that make up each piece of subband data at level 1 are respectively half those of the pixel data in the horizontal direction and the vertical direction that makes up the plane data.

When two-dimensional DWT is applied to the 1LL subband in 600 in FIG. 4, the 1LL subband is subjected to further subband division, and subband data 2LL, subband data 2LH, subband data 2HL, and subband data 2HH at a level 2 as indicated by 610 are obtained. The numbers in the horizontal direction and the vertical direction of coefficients that make up each piece of subband data at the level 2 are respectively half those in the horizontal direction and vertical direction of the pixel data that makes up the subband data at the level 1.

Note that, in this embodiment, the frequency decomposition unit 102 once applies two-dimensional DWT to data of each of the planes that is input. Therefore, the frequency decomposition unit 102 supplies the subband data 1LL that includes low-frequency components, to the super-resolution unit 103 and the entropy encoding unit 106, and supplies the subband data 1LH, subband data 1HL, and subband data 1HH that include high-frequency components, to the high-frequency difference computation unit 104.

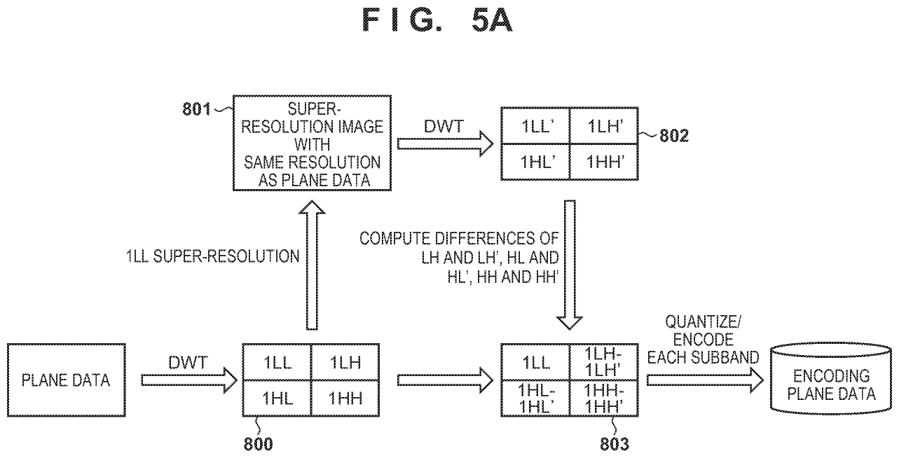

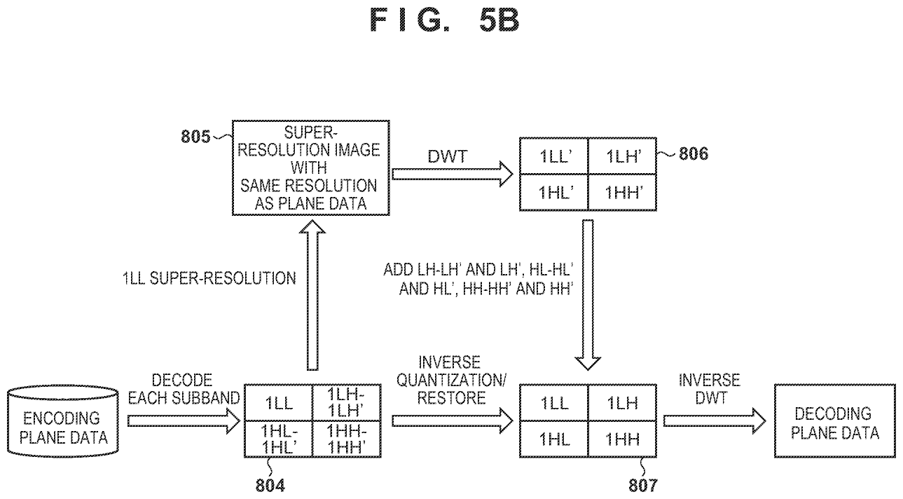

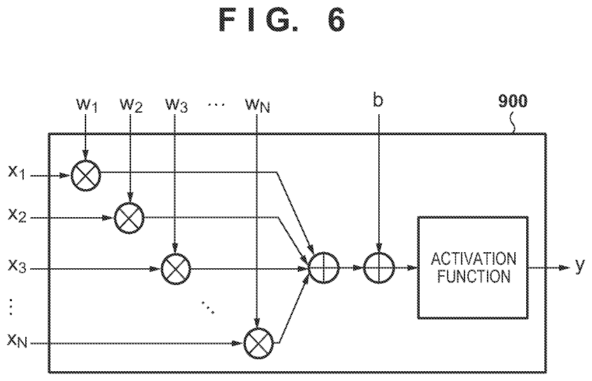

The super-resolution unit 103 (decomposition means) applies super-resolution processing to the 1LL subband data of each of the planes. As indicated by 801 in FIG. 5A, the super-resolution unit 103 generates, through super-resolution processing, data that has the same resolution as that of plane data output from the plane conversion unit 101 (referred to as “super-resolution image data” or “second image data”). The super-resolution unit 103 supplies the generated super-resolution image data to the frequency decomposition unit 102. The super-resolution processing will be described later in detail.

The frequency decomposition unit 102 once applies reversible 5-3 DWT to the super-resolution image data input from the super-resolution unit 103, and generates subband data (1LL′ and high-frequency components 1LH′, 1HL′, and 1HH′) at the level 1. The frequency decomposition unit 102 then supplies high-frequency components 1LH′, 1HL′, and 1HH′ to the high-frequency difference computation unit 104.

Two sets of high-frequency component subband data are supplied from the frequency decomposition unit 102 to the high-frequency difference computation unit 104. One of the two sets is high-frequency component subband data (1LH, 1HL, and 1HH) and has been obtained as a result of applying subband division to plane data. In addition, the other set is high-frequency component subband data (1LH′, 1HL′, and 1HH′) obtained as a result of applying subband division to super-resolution image data that is based on 1LL.

The high-frequency difference computation unit 104 computes the difference between subband data (plane data) and subband data (super-resolution image data) of the same type, for the two sets of high-frequency component subband data. Specifically, the high-frequency difference computation unit 104 computes 1LH-1LH′, 1HL-1HL′, and 1HH-1HH′ as indicated by 803 in FIG. 5A, and supplies the computation results to the quantization unit 105.

The quantization parameter setting unit 107 determines quantization parameters to be applied to the differences between the subbands of each plane in accordance with a compression rate set by the user, and supplies the quantization parameters to the quantization unit 105. Note that, commonly, in order to improve the image quality for the same code amount, higher-frequency subbands that have less visual influence and lower-level subbands are quantized further. Therefore, when frequency decomposition is carried out to the level 1, quantization parameters are set such that 1HH-1HH′>1HL-1HL′≈1LH-1LH′.

In addition, the quantization parameter setting unit 107 supplies weights and biases to be set for neurons that make up a neural network, to the super-resolution unit 103. The quantization parameter setting unit 107 also supplies weights and biases to the entropy encoding unit 106.

The quantization unit 105 quantizes subband data differences 1LH-1LH′, 1HL-1HL′ and 1HH-1HH′ supplied from the high-frequency difference computation unit 104, using quantization parameters set by the quantization parameter setting unit 107. The quantization unit 105 supplies the quantized difference data and the quantization parameters to the entropy encoding unit 106.

The entropy encoding unit 106 performs entropy encoding of the low-frequency component 1LL supplied from the frequency decomposition unit 102 and the quantized data of the high-frequency component differences 1LH-1LH′, 1HL-1HL′, and 1HH-1HH′ supplied from the quantization unit 105. There is no limitation to the encoding method, but, for example, EBCOT (Embedded Block Coding with Optimized Truncation) can be used. The entropy encoding unit 106 stores encoded data, quantization parameters, and weights and biases in one data file and outputs the data file, for example, or outputs them as an encoded data stream.

The super-resolution unit 103 will be described further. In this embodiment, the super-resolution unit 103 realizes super-resolution processing using a neural network.

FIG. 6 shows a configuration example of a neuron making up a neural network that is used by the super-resolution unit 103. After multiplying a plurality of input values (here, x₁ to x_{N}) respectively by weights (w₁ to w_{N}) that are separately supplied, and adding the resulting values, a neuron 900 adds a bias b to obtain x′. The neuron 900 further outputs y obtained as a result of inputting x′ to an activation function.

The input values of the neuron 900 are the 1LL subband data that is input to the neural network, or output of upstream or former-stage neurons. In addition, the output y of the neuron 900 is input to other downstream or later-stage neurons, or is output as super-resolution image data from the neural network.

More specifically, computation for obtaining x′ performed by the neuron 900 is represented by Expression 5 below.

x′=Σₙ₌₁^{N}(xₙ·wₙ)+b (5)

Note that weights (w₁ to w_{N}) and the bias b are supplied from the quantization parameter setting unit 107.

Subsequently, x′ obtained using Expression 5 is input to an activation function, and the output y is obtained. The activation function is a non-linear function, and, for example, a sigmoid function represented as Expression 6 or a ReLU (ramp function) represented as Expression 7 can be used, but there is no limitation thereto.

y=1/(1+e^{-x′}) (6)

y=0(x′≤0), y=x′ (x′=0) (7)

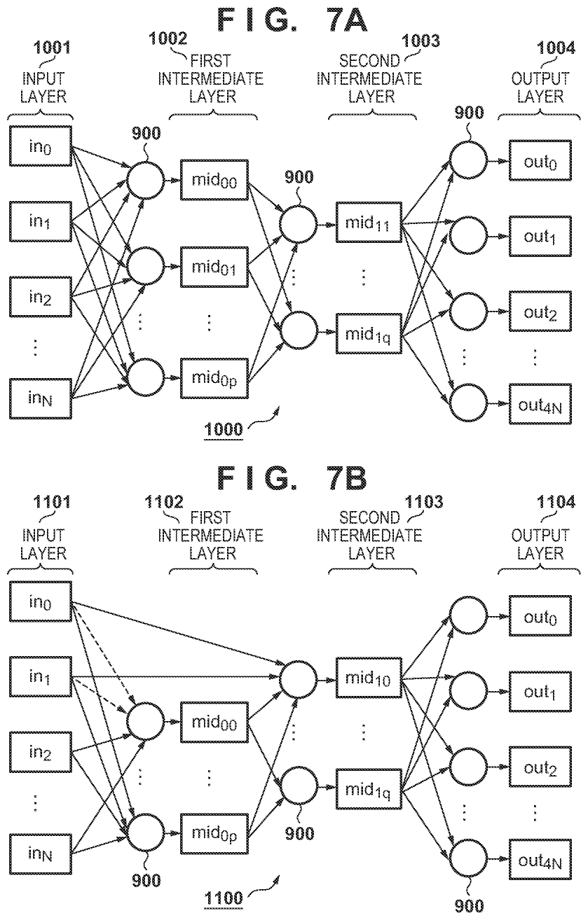

FIG. 7A is a diagram showing a configuration example of a neural network 1000 in which the neurons 900 are used. The neural network 1000 is configured by four layers, namely an input layer 1001, a first intermediate layer 1002, a second intermediate layer 1003, and an output layer 1004. A plurality of neurons 900 are arranged between the layers.

Data in each of the layers is input to neurons 900, and output of neurons 900 becomes data of the next layer. The number of pieces of data of the first intermediate layer 1002 and the number of pieces of data of the second intermediate layer 1003 do not need to be the same. Therefore, the number of neurons 900 provided between layers may be any number other than 0. Note that, in this embodiment, in order to realize super-resolution processing for quadruplicating the number of pieces of data, the neural network 1000 is configured such that the number of pieces of data of the output layer is 4N with respect to the number of pieces of data N of the input layer.

in₀ to in_{N} of the input layer 1001 indicate 1LL subband data that is input to the neural network 1000. In addition, out₀ to out_{4N} of the output layer 1004 is super-resolution pixel data that is output by the neural network 1000.

FIG. 7B is a diagram showing a configuration example of another neural network 1100 in which the neurons 900 are used. The neural network 1100 includes skip connection. Broken arrows between an input layer 1101 and a first intermediate layer 1102 indicate skip connection, and in₀ and in₁ are directly input to neurons 900 arranged between the first intermediate layer 1102 and a second intermediate layer 1103. In this manner, the neural network that is used by the super-resolution unit 103 may be configured to include skip connection,

In addition, a neural network that has any other configuration, such as a CNN (Convolution Neural Network) or a DBN (Deep Brief Network) may also be used. In addition, the number of layers of the neural network is not limited to four, and it is possible to use a neural network that includes any number of plurality of layers.

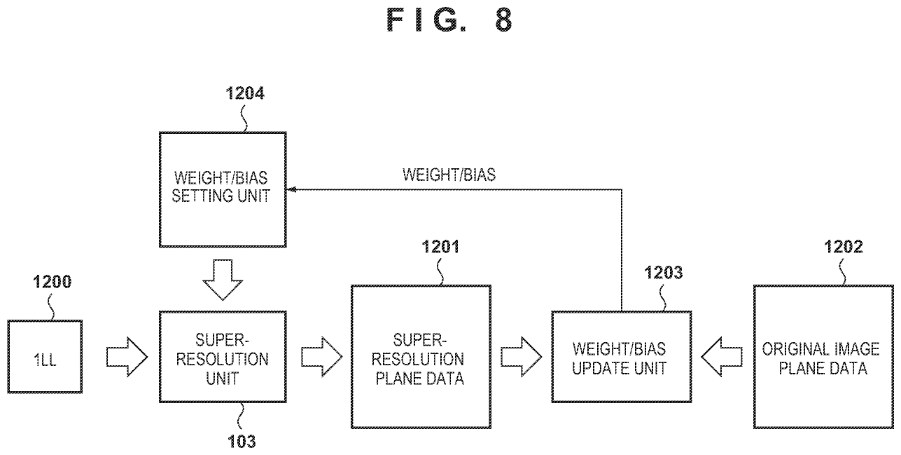

Next, a method for determining weights and biases to be applied to neurons 900 will be described. In this embodiment, these parameters are determined based on a configuration such as that shown in FIG. 8, using machine learning. A weight/bias update unit 1203 and a weight/bias setting unit 1204 shown in FIG. 8 may have the configuration of the encoding apparatus 100 (for example, a portion of the quantization parameter setting unit 107), or may also have the configuration of a learning apparatus other than the encoding apparatus 100.

When learning is performed, 1LL subband data 1200 that is output from the frequency decomposition unit 102 in FIG. 1A is supplied to the super-resolution unit 103. The weight/bias setting unit 1204 sets weights and biases for the super-resolution unit 103. Initial values of the weights and biases may be any values, and, for example, random numbers can be used.

The super-resolution unit 103 executes super-resolution processing using, in the neurons 900, the set weights and bias, and generates super-resolution plane data 1201 that has the same resolution as the plane data before subband division (resolution that is four times the resolution of the 1LL subband data). The super-resolution unit 103 supplies the super-resolution plane data 1201 to the weight/bias update unit 1203.

The super-resolution plane data 1201 and original image plane data 1202 before subband division on which the 1LL subband data is based are input to the weight/bias update unit 1203. The original image plane data 1202 corresponds to plane data that is output by the plane conversion unit 101.

The weight/bias update unit 1203 compares the super-resolution plane data 1201 with the original image plane data 1202, and updates the weights and biases using a back propagation method or the like, such that the super-resolution plane data 1201 approximates the original image plane data. The weight/bias update unit 1203 supplies the updated weights and biases to the weight/bias setting unit 1204. Accordingly, the weights and biases that are to be supplied from the weight/bias setting unit 1204 to the super-resolution unit 103 are updated.

PSNR (Peak signal-to-noise ratio), the sum of absolute differences, or the like can be used as an index that is used when the weights and biases are updated, but there is no limitation thereto. When PSNR is used, the weights and biases are updated such that PSNR increases. Also, when the sum of absolute differences is used, the weights and biases are updated such that the sum of absolute differences decreases.

Weights and a bias to be applied in neurons of the neural network of the super-resolution unit 103 are determined by executing the above-described processing for updating the weights and bias, on a large amount of training data, The super-resolution unit 103 can generate super-resolution image data that is close to the original plane data, by determining weights and a bias using machine learning in this manner. As a result, high-frequency components that are obtained by performing subband division on super-resolution image data are also close to high-frequency components that are obtained by performing subband division on the original plane data.

Therefore, values that are close to 0 are dominant in difference results between the high-frequency components that are based on the super-resolution data and the high-frequency components that are based on the plane data, the results being obtained by the high-frequency difference computation unit 104, and the encoding efficiency of entropy encoding can be improved.

Note that, in this embodiment, a configuration has been described in which subband division that is performed through two-dimensional DWT is applied once. However, subband division may also be applied a plurality of times. Also when subband division is applied a plurality of times, super-resolution processing is performed on LL subband data. Subband division is applied to LL subband data, and thus, regardless of the number of times subband division is applied, there is only one type of LL subband data.

For example, when subband division is applied twice as indicated by 610 in FIG. 4, super-resolution processing is applied to 2LL subband data. The super-resolution unit 103 applies, to LL subband data, super-resolution processing for multiplying the resolution (the number of pieces of data) in each of the horizontal direction and the vertical direction by 2p (p is the number of times subband division is applied). In addition, three types of high-frequency component subband data between which the differences are computed by the high-frequency difference computation unit 104 are pHL, pLH, and pHH based on 1HL, 1LH, and 1HH.

In addition, in this embodiment, two-dimensional DWT is used as a method for dividing image data into frequency components, but another frequency decomposition method may also be used. It is possible to use DCT (Discrete Cosine Transform) that is used for a standard such as MPEG2 or H.264.

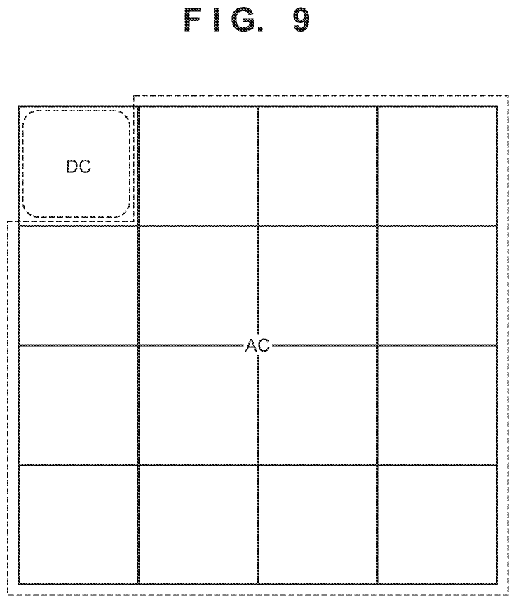

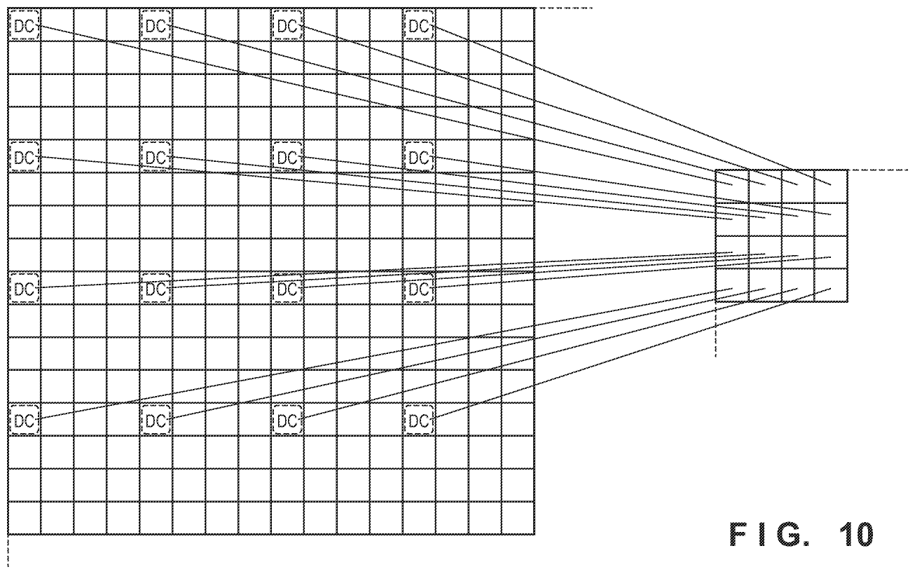

In H.264, image data to be encoded is divided into macro blocks of 16 pixels horizontally×16 pixels vertically, DCT is further applied in unites of blocks of 4 pixels×4 pixels, frequency decomposition is performed, and encoding is then performed. FIG. 9 is a diagram schematically showing a DCT coefficient obtained as a result of applying DCT. From among 4×4 coefficients, the upper left coefficient is referred to as a “DC coefficient”, and the other coefficients are referred to as “AC coefficients”. The frequency decomposition unit 102 can configure low-frequency components (subband data) to be subjected to super-resolution processing, by extracting a DC coefficient for each block that is a unit for performing DCT, as shown in FIG. 10. When DCT is applied to each block of 4 pixels×4 pixels, subband data constituted by DC coefficients has a resolution that is 1/16 of the resolution of the original data. Therefore, the super-resolution unit 103 apples, to subband data, super-resolution processing for quadrupling the resolution both in the horizontal direction and the vertical direction. Even if the size of blocks to which DCT is applied is different, processing is basically similar except that the magnification of super-resolution processing is different. Note that, similar to the case of the 1LL subband. coefficient, quantization is not performed regarding DC coefficients.

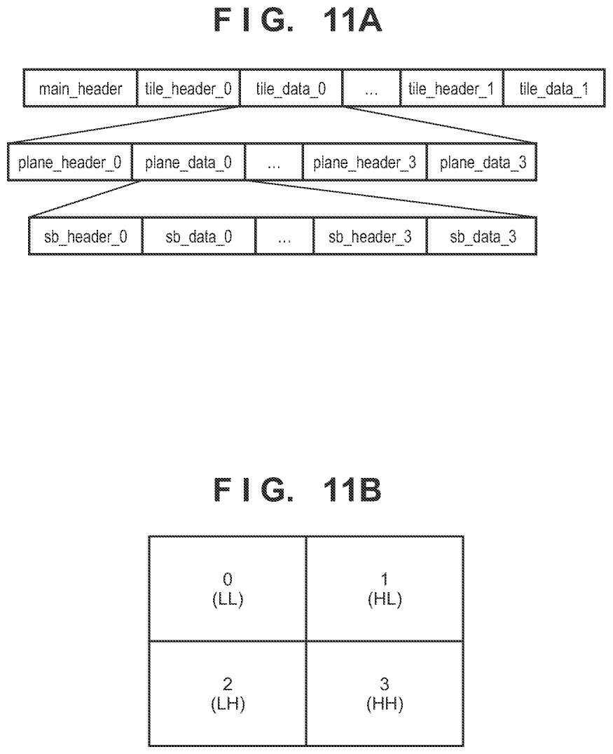

An example of a data format for recording an encoding result (encoded RAW image data and quantization parameters) will be described with reference to FIGS. 11A and 1113. The data format has a hierarchical structure shown in FIG. 11A. Data starts from “main_header” that indicates information related to the entire encoded data. In FIG. 11A, since it is expected that RAW image data are encoded in units of pixel blocks (tiles), “tile_header” and “tile_data” are repeatedly included. When encoding is not performed in units of blocks, one “tile_header” and one “tile_data” are included.

Encoded RAW image data is sequentially stored in “tile_data” in units of planes, “plane_header” indicating information regarding each plane and “plane_data” indicating encoded data of the plane are repeated for every plane. “plane_data” indicating encoded data for each plane is constituted by encoded data for a subband. Therefore, in “plane_data”, “sb_header” indicating information regarding each subband and “sb_data” indicating encoded data for the subband are arranged in the order of subband index. Subband indexes are allocated as shown in FIG. 118, for example. According to this embodiment, quantization of subband data that includes low-frequency components (LL, subband data and DC coefficient) is not performed. Thus, regarding a subband index 0, data obtained as a result of performing entropy encoding of a coefficient is stored. In addition, regarding subband indexes 1 to 3 corresponding to high-frequency components, data obtained through quantization and entropy encoding of differences calculated by the high-frequency difference computation unit 104 is stored.

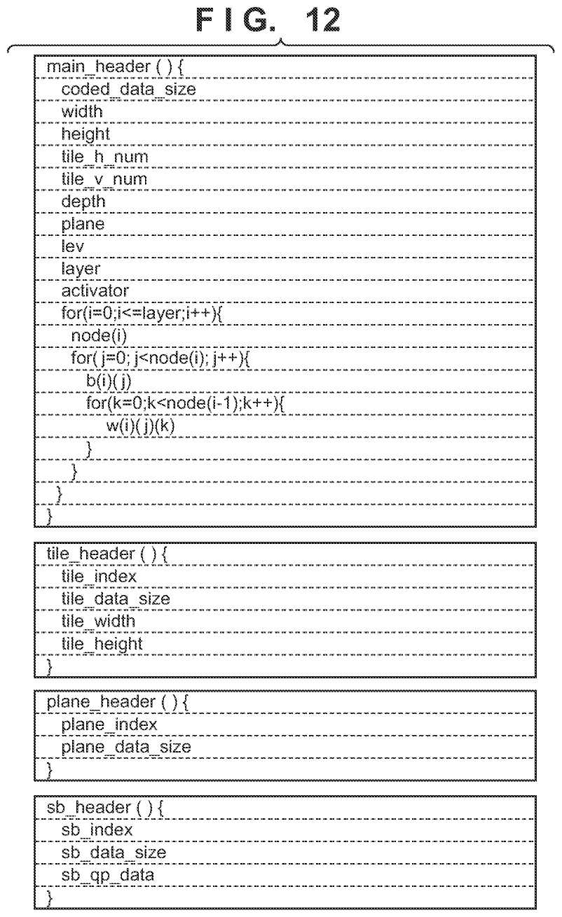

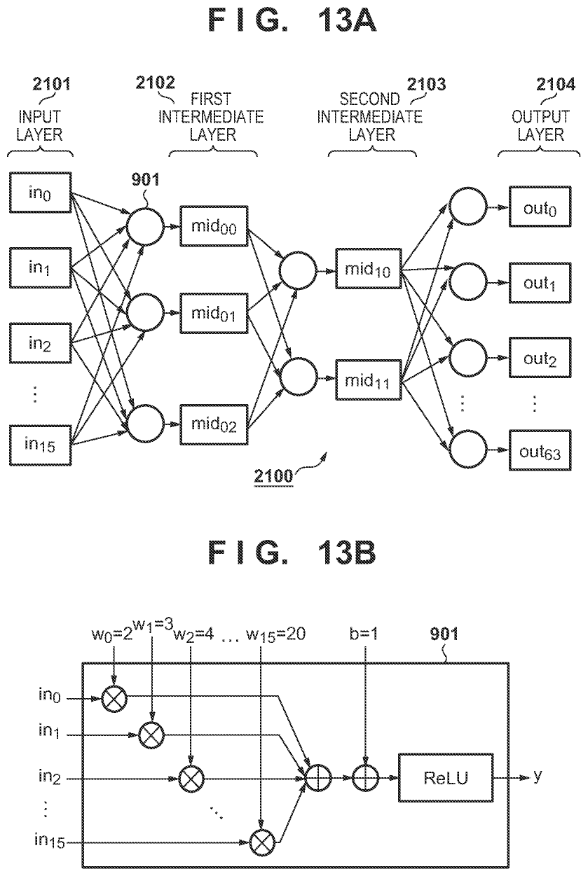

For example, FIG. 12 shows a specific example of syntax elements of each piece of header information when a neural network that has the configuration shown in FIG. 7A is used.

“main_header” stores the following information.

“coded_data_size”: the data amount of entire encoded RAW image data

“width”: the width of RAW image data

“height”: the height of RAW image data

“depth”: the bit depth of RAW image data

“plane”: the number of planes when RAW image data was encoded

“lev”: the subband breakdown level of each plane

“layer”, “activator”, “node” “b”, and “w” are syntax elements that indicate a configuration of the neural network during super-resolution processing.

“layer”: the number of intermediate layers

“activator”: information for specifying an activation function. For example, “0” indicates information for specifying a sigmoid function, and “1” indicates information for specifying ReLU. The type and the number of pieces of information, and the type of function and the number of functions are merely exemplary, and can be set to any values.

“node”: the number of neurons in each intermediate layer for super-resolution processing

“b”: bias for each neuron

“w”: weight that is input to each neuron and is multiplied by neurons in the former layer

Syntaxes related to the neural network will be described later in detail.

“tile (reader” includes the following information.

“tile_index”: tile index for identifying a tile divided position

“tile_data_size”: the encoded data amount included in a tile

“tile_width”: the width of the tile

“tile_height”: the height of the tile

“plane_header” includes the following information.

“plane_index”: a plane index for identifying a plane

“plane_data_size”: an encoded data amount of a plane

“sb_header” includes the following information.

“sb_index”: a subband index for identifying a subband

“sb_data_size”: the encoded data amount of a subband

“sb_qp_data”: a quantization parameter of each subband

A configuration can be adopted in which, when syntax elements of each header are configured as shown in FIG. 12, the encoding apparatus can update the configuration of the neural network of the encoding apparatus itself based on header information regarding the configuration of the neural network. In this case, it is possible to change, from the outside, the weights and biases used in the neurons of the neural network that is used by the super-resolution unit 103 of encoding apparatus. Thus, the weights and biases whose accuracy has been improved as a result of progressed training can be set in the super-resolution unit 103 through, for example, update of firmware for a device in which the encoding apparatus according to this embodiment is mounted. Therefore, it is possible to further improve the encoding efficiency of the mounted encoding apparatus.

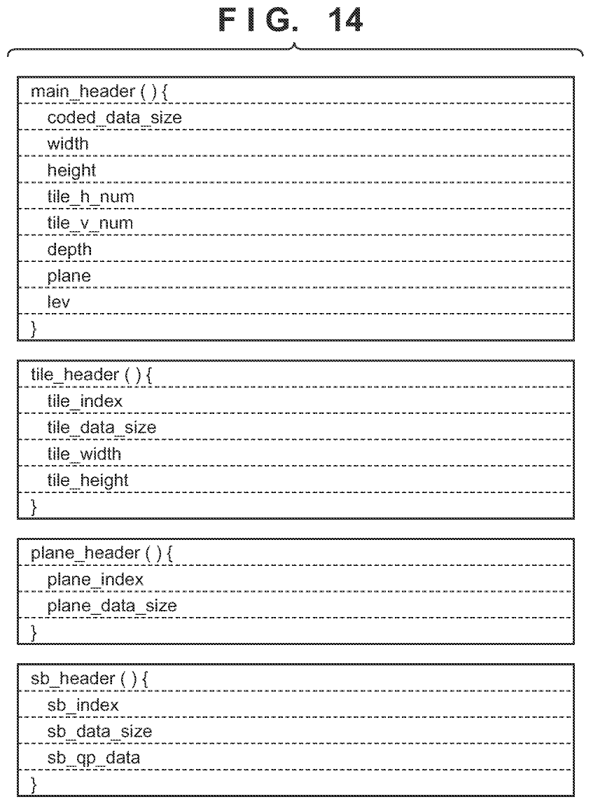

Next, the relationship between a specific configuration of the neural network and syntaxes “layer”, “activator”, “node” “b”, and “w” related to the neural network included in “main_header” will be described with reference to FIG. 13A. Note that, here, encoded 1LL subband data is made up of 4×4=16 coefficients. Therefore, information corresponding to the neural network with 16 inputs and 64 outputs as shown in FIG. 13A, for example, is stored in each item,

FIG. 13B shows a configuration example of a neuron 901 connected to an input layer 2101 and mid₀₀ of a first intermediate layer 2102 in FIG. 13A. The basic configuration is similar to that of the neuron 900 shown in FIG. 6. First, the neural network in FIG. 13A includes two intermediate layers, and thus “layer”=2. In addition, as shown in FIG. 13B, in the neuron 901, when ReLU is used as an activation function, “activator”=1.

The number of neurons that are connected to the first intermediate layer 2102 is three, the number of neurons that are connected to a second intermediate layer 2103 is two, and the number of neurons that are connected to an output layer 2104 is 64. Therefore, “node (0)”=3, “node (1)”=2, and “node (2)”=64. In “node (i)”, i indicates a layer number. i=0 corresponds to the first intermediate layer.

In “bias b(i)(j)”, indicates a layer number, and j indicates a neuron number. The neuron number j is a number assigned in the order of element of the layer to which the neuron is connected. “b (0) (0)” indicates a bias value that is set for the neuron 901 connected to mid₀₀ from among three neurons connected to the first intermediate layer 2102. In the case of the neuron 901 shown in FIG. 1313, “b (0) (0)”=1.

Similarly, the bias value of a neuron connected to mid₀₁ in FIG. 13A is stored in “b (0) (1)”, and the bias value of a neuron connected to mid₀₂ in FIG. 13A is stored in “b (0) (2)”.

In w (i) (j) (k), i indicates a layer number, j indicates a neuron number, and k indicates a neuron number of a former layer. In addition, the total number of “w” is the same as the number of neurons of the immediately former layer. The LL subband coefficient is input to the neurons connected to the first intermediate layer 2102, and thus the total number of weights w is 16.

As shown in FIG. 13B, a weight w is multiplied to the output of a neuron of the former layer that is input to the neuron. “w (0) (0) (0)” indicates a weight that is multiplied to input in₁, in the neuron 901 connected to mid₀₀ of the first intermediate layer 2102 shown in FIG. 13B, Similarly, “w (0) (0) (1)” indicates a weight that is multiplied to in₁, “w (0) (0) (2)” indicates a weight that is multiplied to in₂, and “w (0) (0) (15)” indicates a weight that is multiplied to Therefore, in the case of the neuron 901 in FIG. 13B, “w (0) (0) (0)”=2, “w (0) (0) (1)”=3, “w (0) (0) (2)”=4, . . . “w (0) (0) (15)”=20 are stored,

Also regarding other neurons, weights are stored similarly. Weights for the neurons connected to mid₀₁ of the first intermediate layer 2102 are stored in “w (0) (1) (n)” (n=0 to 15). Weights for the neurons connected to mid₀₂ of the first intermediate layer 2102 are stored in “w (0) (2) (n)” (n=0 to 15).

Also regarding other neurons, biases and weights are stored similarly. Regarding neurons connected the output layer 2104, “b (2) (0)”, “b (2) (63)”, weights “w (2) (0) (0)”, . . . “w(2) (63) (1)” are stored.

As a result of information being included in each item as described above, the decoding apparatus can restore the neural network used when super-resolution image data was generated during encoding. It is also possible to update the configuration of the neural network of the decoding apparatus.

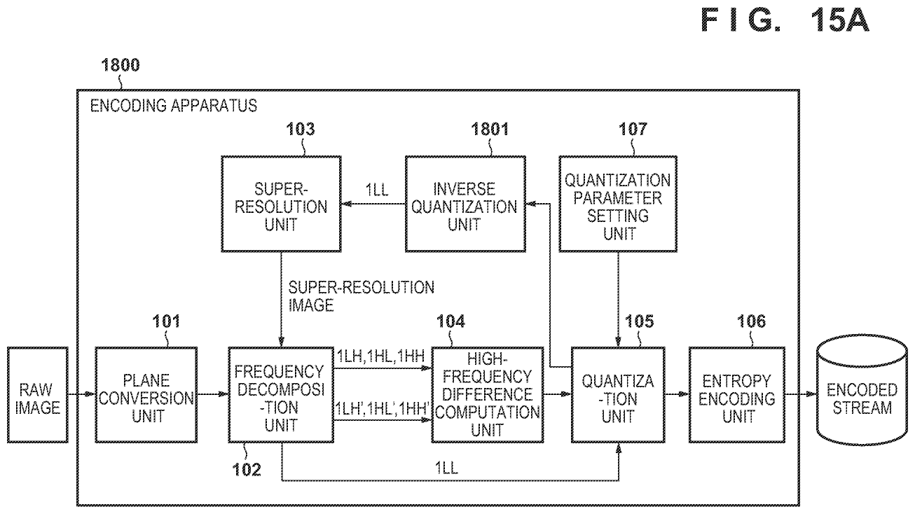

Subsequently, another configuration example of syntax elements of each piece of header information will be described with reference to FIG. 14.

Note that, in FIG. 12, the syntax elements “layer”, “activator”, “node”, “b”, and “w” related to the configuration of the neural network used for super-resolution processing during encoding are included in “main_header”, but these are not essential. For example, as shown in FIG. 14, “main_header” does not need to include “layer” “activator”, “node”, “b”, and “w” that are syntax elements related to the configuration of the neural network.

When encoded data is recorded in the format in FIG. 14, the encoding apparatus and the decoding apparatus use neural networks that have the same and fixed configuration. In this case, the accuracy of super-resolution processing that uses a neural network cannot be improved by updating firmware, for example, but the size of the encoded data file can be reduced.

Encoded data that is generated by the above-described encoding apparatus can be decoded by a decoding apparatus that performs reverse processing of the processing of the encoding apparatus. FIG. 1B is a block diagram showing an exemplary function configuration of a decoding apparatus that forms a pair with the encoding apparatus in FIG. 1A. A decoding apparatus 200 includes an entropy decoding unit 201, a dequantization unit 202, a super-resolution unit 203, a frequency decomposition unit 204, a high-frequency restoration unit 205, a frequency recomposition unit 206, and a Bayer conversion unit 207. These units (functional blocks) can be realized by a dedicated hardware circuit such as an ASIC, as a result of a general-purpose processor such as a DSP or a CPU loading a program stored in a non-volatile memory to a system memory and executing the program, or by a combination thereof. For convenience, a description will be given below assuming that each functional block autonomously operates in cooperation with other functional blocks.

The entropy decoding unit 201 decodes encoded wavelet coefficients as indicated by 804 in FIG. 5B, through EBCOT (Embedded Block Coding with Optimized Truncation) or the like. The entropy decoding unit 201 supplies decoded low-frequency component subband data 1LL to the super-resolution unit 203 and the frequency recomposition unit 206. Also, the entropy decoding unit 201 supplies data of differences of decoded high-frequency components 1LH-1LH′, 1HL-1HL′, and 1HH-1HH′ and quantization parameters to the dequantization unit 202. Furthermore, if the encoded data file includes elements related to the configuration of the neural network (“layer”, “activator” “node”, “b”, “w”), the entropy decoding unit 201 supplies such information to the super-resolution unit 203.

The dequantization unit 202 performs dequantization on the restored high-frequency component differences 1LH-1LH′, 1HL-1HL′, and 1HH-1HH′ provided from the entropy decoding unit 201, using the quantization parameters, and supplies the resultant to the high-frequency restoration unit 205.

The super-resolution unit 203 applies super-resolution processing to the low-frequency component subband data 1LL input from the entropy decoding unit 201, generates data that has the same resolution as that of the plane data before subband division (super-resolution image data), and supplies the generated data to the frequency decomposition unit 204. This processing corresponds to the processing for generating 805 from 804 in FIG. SB. The super-resolution unit 203 also generates high-resolution data from subband data using a neural network. Note that, if information regarding a configuration of a neural network has been supplied from the entropy decoding unit 201, the super-resolution unit 203 configures a neural network based on the supplied information, and uses it for super-resolution processing.

The frequency decomposition unit 204 executes reversible 5-3 DWT on the super-resolution image data once, and performs subband division to obtain a low-frequency component 1LL′ and high-frequency components 1LH′, 1HL′, and 1HH′. This processing corresponds to the processing for generating 806 from 805 in FIG. 5B. The frequency decomposition unit 204 supplies subband data of the high-frequency components 1LH′, 1HL′, and 1HH′ to the high-frequency restoration unit 205.

The high-frequency restoration unit 205 adds the high-frequency component difference data supplied from the dequantization unit 202 to the high-frequency component subband data transmitted from the frequency decomposition unit 204, for each corresponding subband. Specifically, the high-frequency restoration unit 205 adds 1LH′ to 1LH′-1LH′, 1HL′ to 1HL-1HL′, and 1HH′ to 1HH-1HH′. Accordingly, the high-frequency restoration unit 205 restores subband data of the high-frequency components 1LH, 1HL, and 1HH as indicated by 807 in FIG. 5B. This restoration corresponds to obtaining addition data of high-frequency component subband data. The high-frequency restoration unit 205 supplies the restored subband data of the high-frequency components 1LH, 1HL, and 1HH to the frequency recomposition unit 206.

The frequency recomposition unit 206 applies frequency recomposition to the subband data of the low-frequency component 1LL supplied from the entropy decoding unit 201 and the subband data of the restored high-frequency components 1LH, 1HL and 1HH supplied from the high-frequency restoration unit 205. Frequency recomposition is reverse processing of frequency decomposition performed during encoding, and is reversible 5-3 inverse DWT (Inverse Discrete Wavelet Transform). Data for one plane is obtained through frequency recomposition. The frequency recomposition unit 206 supplies data of R, G0, B, and G1 planes included in encoded data, to the Bayer conversion unit 207.

A specific method for applying reversible 5-3 inverse DWT will be described with reference to FIG. 3B. In FIG. 3B, a′, c′, and e′ indicate high-frequency component DWT transform coefficients, and b″ and d″ indicate low-frequency component DWT transform coefficients. In addition, b and d indicate pixel data of even-numbered planes when the pixel at a DWT start position is set as 0, and c indicates pixel data of an odd-numbered plane when the pixel at a DWT start position is set as 0. The pixel data h and the pixel data d of even-numbered planes when the pixel at the DWT start position is set as 0 are obtained based on the following equations.

b=b″−(a+c′+2)/4 (8)

d=d″−(c+e′+2)/4 (9)

Expressions 8 and 9 use different pieces of pixel data, but the same computation is performed in the equations.

In addition, the pixel data c of an odd-numbered color plane when the pixel at a DWT start position is set as 0 is obtained based on the following equation.

c=c′+(b+d)/2 (10)

Inverse DWT shown in FIG. 3B is one-dimensional inverse DWT. As a result of carrying out one-dimensional inverse DWT in the horizontal direction and vertical direction of subband data, recomposition is performed to obtain data of the planes.

The Bayer conversion unit 207 recombines the data of the R, G0, B, and G1 planes supplied from the frequency recomposition unit 206, so as to arrange the pixels in the Bayer array, and outputs the data as decoded RAW image data.

In this embodiment, when an image is subjected to subband division and is encoded, regarding the high-frequency component subband data, difference from high-frequency component subband data obtained by performing subband division on an image generated based on low frequency component subband data is encoded. Accordingly, the encoding data amount related to high-frequency components can be reduced in a large amount, and favorable encoding efficiency can be realized, in addition, regarding the low-frequency component subband data, image quality deterioration is not caused by a quantization error, as a result of not quantizing low-frequency components subband data, and thus high-quality decoded image data can be obtained.

In addition, by increasing the resolution of the low-frequency component subband data using a trained neural network, it is possible that most of the difference results of high-frequency components are present in the vicinity of 0, and realize further improvement in the encoding efficiency. In addition, it is possible to improve the performance of a neural network of a decoding apparatus if encoded data includes information for the decoding apparatus to configure a neural network that is used for encoding.

In the encoding apparatus according to this embodiment, conversion into planes is not necessary. In addition, the encoding apparatus according to this embodiment is applicable to encoding of any image, not limited to RAW image data.

### Second Embodiment

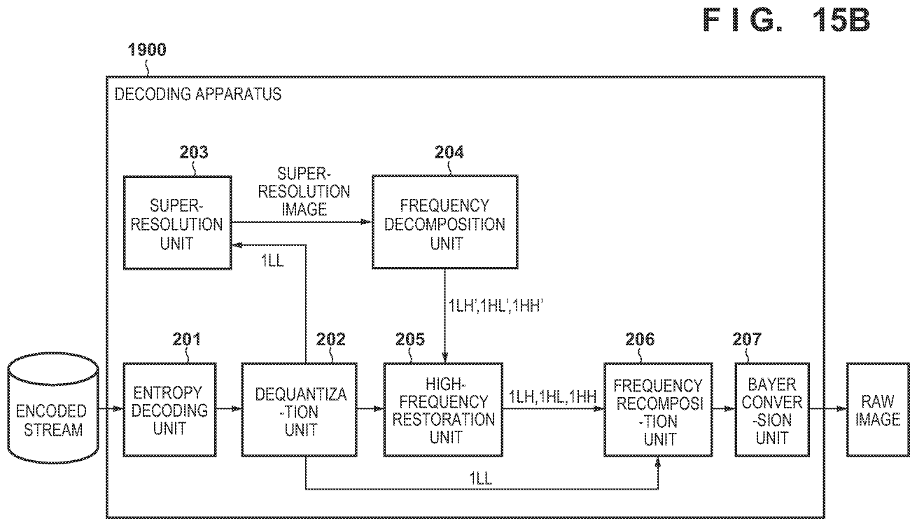

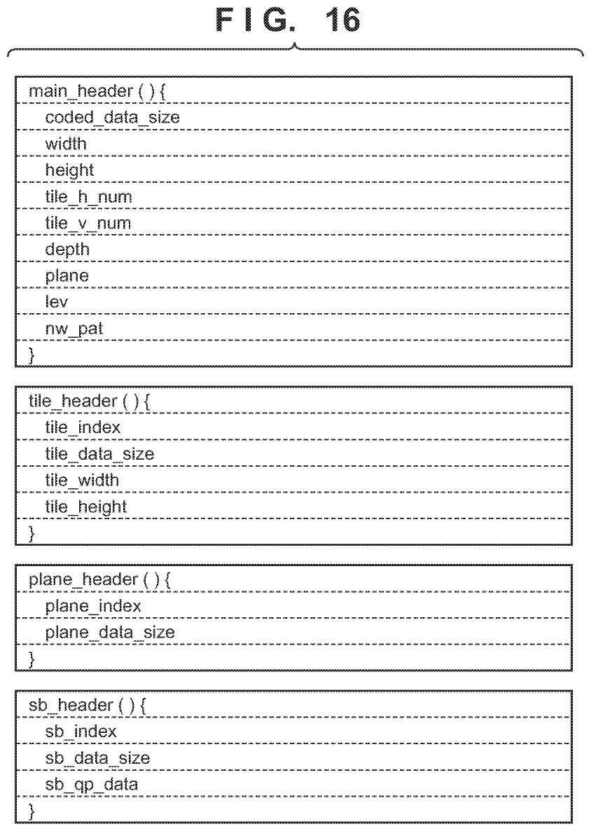

Next, a second embodiment of the present disclosure will be described with reference to FIG. 15A. In FIG. 15A, the same reference numerals are assigned to functional blocks that are similar to those of the encoding apparatus 100 described in the first embodiment. An encoding apparatus 1800 according to this embodiment has a functional configuration similar to that of the encoding apparatus 100 described in the first embodiment, except that a dequantization unit 1801 is included. Therefore, differences from the first embodiment will be described below mainly.

In the first embodiment, a configuration is adopted in which subband data of a low-frequency component 1LL is not quantized, but, in this embodiment, subband data of 1LL is also quantized. The quantized subband data of 1LL is then subjected to dequantization performed by the dequantization unit 1801, and is supplied to the super-resolution unit 103.

Therefore, according to this embodiment, the frequency decomposition unit 102 supplies subband data of 1LL to the quantization unit 105, instead of the super-resolution unit 103.

The quantization unit 105 then quantizes subband data of 1LL using quantization parameters set by the quantization parameter setting unit 107, and supplies the data to the entropy encoding unit 106 and the dequantization unit 1801.

The quantization parameter setting unit 107 can set, in the quantization unit 105 and the dequantization unit 1801, quantization parameters that are based. on a compression rate set by the user, for example, as quantization parameters to be applied to subband data of 1LL.

The dequantization unit 1801 performs dequantization on the quantized subband data of 1LL supplied from the quantization unit 105, using the quantization parameters used during quantization, and supplies the data to the super-resolution unit 103.

The super-resolution unit 103 generates super-resolution image data by applying super-resolution processing to the 1LL subband data input from the dequantization unit 1801, similarly to the first embodiment, and supplies the super-resolution image data to the frequency decomposition unit 102.

Operations of the frequency decomposition unit 102 and operations of the high-frequency difference computation unit 104 that are performed on super-resolution image data are similar to those in the first embodiment, and thus a description thereof is omitted.

The quantization parameter setting unit 107 sets a quantization parameter for quantizing difference data of high-frequency components, for the quantization unit 105. This quantization parameter may be determined in accordance with compression rate set by the user, for example. Note that, as a result of quantizing a higher-frequency subband, which has less visual influence, and a lower-level subband in a larger quantization step, deterioration in the image quality can be suppressed for the same code amount. For example, when the frequency decomposition unit 102 applies subband division at the level 1, it is possible to set a quantization parameter that satisfies a magnitude relationship of a quantization step for 1HH-1HH′>a quantization step for 1HL-1HL′≈a quantization step for 1LH-1LH′. The quantization parameter setting unit 107 can prepare, in advance, a quantization parameter that satisfies such a magnitude relationship for each of a plurality of compression rates, and set an appropriate quantization parameter for the quantization unit 105, based on a set compression rate.

The quantization unit 105 quantizes high-frequency component difference data (1LH-1LH′, 1HL-1HL′, 1HH-1HH′) supplied from the high-frequency difference computation unit 104, using the quantization parameter set by the quantization parameter setting unit 107. The quantization unit 105 then supplies the quantized data to the entropy encoding unit 106.

The entropy encoding unit 106 applies entropy encoding such as EBCOT to the quantized low-frequency component subband data 1LL and the quantized high-frequency component difference data, and outputs the resultant as encoded data.

According to this embodiment, it is possible to reduce the encoded data amount more than the first embodiment by quantizing low-frequency components as well.

Note that weights and biases that are set for a neural network to be used for super-resolution processing can be obtained by training, as described in the first embodiment with reference to FIG. 8. Only difference is that DLL subband data 1200 that is input has been subjected to quantization and dequantization, Note that, also in this embodiment, frequency decomposition may be performed using a method other than DWT.

According to this embodiment, a quantization parameter that is applied to 1LL low-frequency component subband data differs in accordance with a set compression rate (corresponding to a recoding image quality in the case of a digital camera). Thus, weights and biases of a neural network may be obtained by training for each compression rate. The time required for training and the data amount of weights and biases that are held increase, but appropriate super-resolution processing can be carried out in accordance with a compression rate.

A configuration example of syntax elements of header information of an encoded data file when training is performed for each compression rate will be described with reference to FIG. 16. Syntax elements in FIG. 16 are different from the syntax elements in FIG. 12 described in the first embodiment in that “main_header” does not include “layer”, “node”, “b”, or “w”, and include “nw_pat”.

“nw_pat” stores information that can specify a compression rate selected by the user. For example, if a compression rate can be selected from three compression rates, namely a low compression, an intermediate compression, and a high compression, values such as low compression: 0, intermediate compression: 1, and high compression: 2 can be stored. Super-resolution processing is performed using weights and biases obtained by training for each set compression rate. In this case, similarly, also in the decoding apparatus, weights and biases that are based on compression rates are held, and weights and a bias that are based on the value of “nw_pat” are set for the neural network during decoding.

Note that syntax elements of each piece of header information may have the configuration in FIG. 14, and weights and biases obtained by training for a set compression rate are selected by referencing “sb_qp_data” of “sb_header”.

Next, a decoding apparatus 1900 that forms a pair with the encoding apparatus 1800 will be described with reference to FIG. 15B. In FIG. 15B, the same reference numerals are assigned to functional blocks that are similar to those of the decoding apparatus 200 described in the first embodiment. The decoding apparatus 1900 according to this embodiment has a functional configuration similar to that of the decoding apparatus 200 described in the first embodiment, except that subband data of 1LL is supplied from the dequantization unit 202 to the super-resolution unit 203. Therefore, differences from the first embodiment will be mainly described below.

The entropy decoding unit 201 decodes encoded wavelet coefficients, through EBCOT (Embedded Block Coding with Optimized Truncation) or the like, as indicated by 804 in FIG. 8B. The entropy decoding unit 201 transfers decoded subband data of the low-frequency component 1LL, data of differences between high-frequency components 1LH-1LH′, 1HL-1HL′ and 1HH-1HH′, and quantization parameters, to the dequantization unit 202.

The dequantization unit 202 performs dequantization on the decoded subband data of the low-frequency component 1LL and data of differences between high-frequency components 1LH-1LH′, 1HL-1HL′ and 1HH-1HH′, which have been supplied from the entropy decoding unit 201, using the quantization parameters. The low-frequency component 1LL subjected to dequantization is supplied to the super-resolution unit 203 and the frequency recomposition unit 206. In addition, 1LH-1LH′, 1HL-1HL′ and 1HH-1HH′ subjected to dequantization are supplied to the high-frequency restoration unit 205.

The super-resolution unit 203 applies the same super-resolution processing as that of the super-resolution unit 103, to the subband data of the low-frequency component 1LL input from the entropy decoding unit 201, and generates data that has the same resolution as the plane data before subband division (super-resolution image data). The super-resolution unit 203 then supplies the generated super-resolution image data to the frequency decomposition unit 204.

The frequency decomposition unit 204 executes reversible 5-3 DWT on the super-resolution image data once, and divides the data into subbands of a low-frequency component 1LL′ and high-frequency components 1LH′, 1HL′, and 1HH′. The frequency decomposition unit 204 supplies subband data of the high-frequency components 1LH′, 1HL′, 1HH′ to the high-frequency restoration unit 205.

The high-frequency restoration unit 205 adds the high-frequency component difference data supplied from the dequantization unit 202 to the high-frequency component subband data transmitted from the frequency decomposition unit 204, for each corresponding subband. Specifically, the high-frequency restoration unit 205 adds 1LH′ to 1LH-1LH′, 1HL′ to 1HL-1HL′, and 1HH′ to 1HH-1HH′. The high-frequency restoration unit 205 supplies the restored subband data of the high-frequency components 1LH, 1HL, 1HH to the frequency recomposition unit 206.

The frequency recomposition unit 206 applies frequency recomposition to the subband data of the low-frequency component DLL supplied from the dequantization unit 202 and the restored subband data of high-frequency components 1LH, 1HL, and 1HH supplied from the high-frequency restoration unit 205. Frequency recomposition is reverse processing of frequency decomposition performed during encoding, and is reversible 5-3 inverse DWT. Data for one plane is obtained through frequency recomposition. The frequency recomposition unit 206 supplies data on the R, G0, B, and G1 planes included in encoded data, to the Bayer conversion unit 207.

The Bayer conversion unit 207 recombines the data of the R, G0, B, and G2 planes supplied from the frequency recomposition unit 206, so as to arrange the pixels in the Bayer array, and outputs the data as decoded RAW image data.

According to this embodiment, subband data of 1LL that is not quantized in the first embodiment is quantized, and thus it is possible to reduce the encoding data amount more.

### Variations

According to the first embodiment, subband data of a low-frequency component 1LL is not quantized, and only data of differences between high-frequency components is quantized, and, according to the second embodiment, both subband data of a low-frequency component 1LL and data of differences between high-frequency components are quantized.

In Variation, processing of each of the plane conversion unit 101, the frequency decomposition unit 102, the super-resolution unit 103, and high-frequency frequency difference computation unit of the encoding apparatus 100 is similar between the first embodiment and the second embodiment, but the quantization unit 105 quantizes different data. Processing of each of the entropy decoding unit 201, the super-resolution unit 203, the frequency decomposition unit 204, the high-frequency restoration unit 205, and the frequency recomposition unit 206 of the decoding apparatus 200 is similar between the first embodiment and the second embodiment, but the dequantization unit 202 performs dequantization on different data.

In Variation 1, in the encoding apparatus 100, subband data of a low-frequency component 1LH, out of data subjected to frequency decomposition performed by the frequency decomposition unit 102 is quantized by the quantization unit 105 similarly to the second embodiment, Data of differences between high-frequency components (1LH-1LH′, 1HL-1HL′, 1HH-1HH′) is encoded by the entropy encoding unit 106 without being quantized by the quantization unit 105. The data amount of the subband data of the low-frequency component 1LL is reduced by performing quantization, and high-frequency components are not quantized since data of differences between the high-frequency components is used and thus the data amount is small. In the decoding apparatus 200, the dequantization unit 202 performs dequantization on the subband data of the low-frequency component 1LL out of data decoded by the entropy decoding unit 201, similarly to the second embodiment. The data subjected to dequantization is then input to the super-resolution unit 203 and the frequency recomposition unit 206, and is subjected to processing similar to that of the second embodiment. The high-frequency component data (actually, high-frequency component difference data) out of decoded data is input to the high-frequency restoration unit without being subjected to dequantization performed by the dequantization unit 202. Subsequently, high-frequency components obtained as a result of the frequency decomposition unit 204 performing frequency decomposition on super-resolution image is added to the high-frequency component data (difference data) decoded by the entropy decoding unit 201.

As described above, in Variation 1, low-frequency component subband data is subjected to quantization (dequantization), and high-frequency component difference data is not subjected to quantization (dequantization). The low-frequency component subband that has a large data amount is quantized, and thus the compression efficiency can be improved, and the data amount can be reduced. In addition, regarding high-frequency components, since data of differences between the high-frequency components is used, the data amount is small, there is the possibility that data will be lost if quantized, and thus entropy encoding is performed without performing quantization, preventing loss of the data.

In addition, as Variation 2, it is also conceivable that, during encoding, both low-frequency component subband data and high-frequency component subband difference data are encoded without quantization, and dequantization is not performed also during decoding.

### Other Embodiments

Embodiment (s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment (s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-201032, filed on Nov. 5, 2019, which is hereby incorporated by reference herein in its entirety.

What is claimed is:

1. An encoding apparatus comprising:
one or more processors that execute a program comprising instructions that cause, when executed by the one or more processors, the one or more processors to function as:
a decomposition unit configured to generate low-frequency component subband data and high-frequency component subband data from image data;
a generation unit configured to generate, from low-frequency component subband data generated from first image data by the decomposition unit, second image data that has a same resolution as that of the first image data;
a computation unit configured to obtain a difference between high-frequency component subband data generated from the first image data by the decomposition unit and high-frequency component subband data generated from the second image data by the decomposition unit; and
an encoding unit configured to encode the low-frequency component subband data of the first image data and the difference in order to generate encoded data.

2. The encoding apparatus according to claim 1, the instructions further cause, when executed by the one or more processors, the one or more processors to function as:
a quantization unit configured to quantize the difference,
wherein the encoding unit encodes the quantized difference.

3. The encoding apparatus according to claim 2,
wherein the quantization unit further quantizes the low-frequency component subband data of the first image data, and
the encoding unit encodes the quantized difference and the quantized low-frequency component subband data.

4. The encoding apparatus according to claim 1, the instructions further cause, when executed by the one or more processors, the one or more processors to function as:
a quantization unit configured to quantize the low-frequency component subband data of the first image data,
wherein the encoding unit encodes the quantized low-frequency component subband data of the first image data.

5. The encoding apparatus according to claim 4,
wherein a quantization parameter that is used for quantization of the low-frequency component subband data of the first image data differs according to setting of a compression rate.

6. The encoding apparatus according to claim 1,
wherein the generation unit generates the second image data from the low-frequency component subband data of the first image data, using a trained neural network,

7. The encoding apparatus according to claim 6,
wherein the encoding unit outputs information regarding a configuration of the neural network and the encoded data,

8. The encoding apparatus according to claim 1,
wherein the decomposition unit generates the low-frequency component subband data and the high-frequency component subband data by applying two-dimensional discrete wavelet transform to image data, and
the low-frequency component is an LL subband, and the high-frequency components are LH, HL, and HH subbands.

9. The encoding apparatus according to claim 1,
wherein the decomposition unit generates the low-frequency component subband data and the high-frequency component subband data by applying discrete cosine transform to image data, and
the low-frequency component is a DC coefficient, and the high-frequency component is an AC coefficient.

10. The encoding apparatus according to claim 1,
wherein the first image data is RAW image data obtained by an image sensor.

11. An image capture apparatus comprising:
an image sensor; and
an encoding apparatus that encodes RAW image data obtained by the image sensor, wherein
the encoding apparatus comprises one or more processors that execute a program comprising instructions that cause, when executed by the one or more processors, the one or more processors to function as:
a decomposition unit configured to generate low-frequency component subband data and high-frequency component subband data from image data;
a generation unit configured to generate, from low-frequency component subband data generated from first image data by the decomposition unit, second image data that has a same resolution as that of the first image data;
a computation unit configured to obtain a difference between high-frequency component subband data generated from the first image data by the decomposition unit and high-frequency component subband data generated from the second image data by the decomposition unit; and
an encoding unit configured to encode the low-frequency component subband data of the first image data and the difference in order to generate encoded data.

12. An encoding method that is executed by an encoding apparatus, the method comprising:
generating, from low-frequency component subband data generated from first image data, second image data that has a same resolution as that of the first image data;
obtaining a difference between high-frequency component subband data generated from the first image data and high-frequency component subband data generated from the second image data; and
encoding the low-frequency component subband data of the first image data and the difference in order to generate encoded data.

13. A non-transitory computer-readable medium that stores a program for causing a computer to function as an encoding apparatus comprising:
a decomposition unit configured to generate low-frequency component subband data and high-frequency component subband data from image data;
a generation unit configured to generate, from low-frequency component subband data generated from first image data by the decomposition unit, second. image data that has a same resolution as that of the first image data;
a computation unit configured to obtain a difference between high-frequency component subband data generated from the first image data by the decomposition unit and high-frequency component subband data generated from the second image data by the decomposition unit; and
an encoding unit configured to encode the low-frequency component subband data of the first image data and the difference in order to generate encoded data.

14. A decoding apparatus comprising:
one or more processors that execute a program comprises instructions that cause, when executed by the one or more processors, the one or more processors to function as:
a decoding unit configured to decode encoded data;
a generation unit configured to generate, from low-frequency component subband data out of data obtained by the decoding unit by decoding the encoded data, second image data that has a same resolution as that of image data corresponding to the encoded data;
a decomposition unit configured to generate low-frequency component subband data and high-frequency component subband data from the second image data;
a computation unit configured to add the high-frequency component subband data generated by the decomposition unit, to high-frequency component subband data out of data obtained by the decoding unit by decoding the encoded data, in order to obtain addition data of high-frequency component subband data; and
a frequency recomposition unit configured to perform frequency recomposition on low-frequency components subband data out of the data obtained by the decoding unit by decoding the encoded data, and the addition data of high-frequency component subband data obtained by the computation unit.

15. The decoding apparatus according to claim 14, wherein the instructions further cause, when executed by the one or more processors, the one or more processors to function as:
a dequantization unit configured to dequantize high-frequency component subband data out of the data obtained by the decoding unit by decoding the encoded data,
wherein the computation unit adds the high-frequency component subband data generated by the decomposition unit, to the high-frequency component subband data that have been dequantized by the dequantization unit.

16. The decoding apparatus according to claim 15,
wherein the dequantization unit dequantizes high-frequency component subband data and low-frequency component subband data obtained by decoding the encoded data, and
the generation unit generates the second image data from the low-frequency component subband data that have been dequantized by the dequantization unit.

17. The decoding apparatus according to claim 14, wherein the instructions further cause, when executed by the one or more processors, the one or more processors to function as:
a dequantization unit configured to dequantize the low-frequency component subband data out of the data obtained by the decoding unit by decoding the encoded data,
wherein the generation unit generates the second image data from the low-frequency component subband data that have been &quantized by the dequantization unit.

18. The decoding apparatus according to claim 14,
wherein the decomposition unit performs the frequency recomposition by applying two-dimensional inverse discrete wavelet transform, and
the low-frequency component is an LL subband, and the high-frequency components are LH, HL, and HH subbands.

19. A decoding method that is executed by a decoding apparatus, the method comprising:
generating, from low-frequency component subband data out of data obtained by decoding encoded data, second image data that has a same resolution as that of image data corresponding to the encoded data;
generating low-frequency component subband data and high-frequency component subband data, from the second image data;
adding high-frequency component subband data generated from high-frequency component subband data out of the data obtained by decoding the encoded data in order to obtain addition data of high-frequency component subband data; and
performing frequency recomposition on low-frequency components subband data out of the data obtained by decoding the encoded data, and on the addition data of the high-frequency component subband data.

20. A non-transitory computer-readable medium that stores a program for causing a computer to function as a decoding apparatus comprising:
a decoding unit configured to decode encoded data;
a generation unit configured to generate, from low-frequency component subband data out of data obtained by the decoding unit by decoding the encoded data, second image data that has a same resolution as that of image data corresponding to the encoded data;
a decomposition unit configured to generate low-frequency component subband data and high-frequency component subband data from the second image data;
a computation unit configured to add the high-frequency component subband data generated by the decomposition unit, to high-frequency component subband data out of data obtained by the decoding unit by decoding the encoded data, in order to obtain addition data of high-frequency component subband data; and
a frequency recomposition unit configured to perform frequency recomposition on low-frequency components subband data out of the data obtained by the decoding unit by decoding the encoded data, and the addition data of high-frequency component subband data obtained by the computation unit.
